(19) United States
(12) Patent Application Publication
(10) Pub. No.: US 2024/0294779 A1
(43) Pub. Date: Sep. 5, 2024

(54) MULTILAYER COATING FILM-FORMING METHOD

(71) Applicant: KANSAI PAINT CO., LTD., Hyogo (JP)

(72) Inventors: Nobuhiko NARITA, Kanagawa (JP); Kenji SAKAI, Kanagawa (JP)

(73) Assignee: KANSAI PAINT CO., LTD., Hyogo (JP)

(21) Appl. No.: 18/275,735

(22) PCT Filed: Mar. 28, 2022
(86) PCT No.: PCT/JP2022/015208

§ 371 Date: Aug. 3, 2023

(30) Foreign Application Priority Data
May 18, 2021 (JP) 2021-083760

(51) Int. Cl. C09D 5/22; C09D 7/20; C09D 7/61; C09D 175/04

(52) U.S. Cl. CPC C09D 5/22; C09D 7/20; C09D 7/61; C09D 175/04

(57) ABSTRACT

A multilayer coating film-forming method including: (1) applying a photoluminescent coating material composition (Y) onto an object to be coated to form a photoluminescent coating film; (2) applying a clear coating material composition (Z) containing (z1) a hydroxyl group-containing resin and (z2) a polyisocyanate compound onto the photoluminescent coating film produced in (1) to form a clear coating film; and (3) heating, separately or simultaneously, the photoluminescent coating film formed in (1) and the clear coating film formed in (2) to cure the photoluminescent coating film and the clear coating film, the photoluminescent coating material composition (Y) containing an indium particle (y1), a surface conditioner (y2), and an organic solvent (y3), and a solid content being from 0.1 to 15 mass %.

### TECHNICAL FIELD

The present invention relates to a multilayer coating film-forming method.

### BACKGROUND ART

The purpose of applying paint is mainly to protect a material and to impart aesthetic appearance. For industrial products, aesthetic appearance, especially “texture”, is important from the viewpoint of increasing the product appeal. Textures of industrial products desired by consumers are diverse, but in recent years, lustrous feels, such as metal-like lustrous feels, are in demand in the fields, such as automobile outer panels, automobile parts, and home electrical appliances (hereinafter described as “metallic luster”).

The metallic luster is a texture characterized by, like a specular surface, the absence of granularity. Furthermore, the coated plate having such a texture shines brilliantly when viewed from substantially perpendicular to the coated plate (highlight), but presents dark appearance when viewed from diagonally above of the coated plate (shade). That is, there is a large luminance difference between the highlight area and the shade area.

Techniques to impart such metallic luster to the surface of industrial products include metal plating processing and metal vapor deposition processing (e.g., see Patent Document 1). However, if a coating can provide metallic luster, it is advantageous from the viewpoints of ease of operation, cost, and the like.

Patent Document 2 describes that good metallic appearance can be provided by a metallic coating material produced by diluting a metallic coating base agent containing a nonvolatile solid component including a photoluminescent pigment and a resin and a solvent with a diluent containing a high-boiling-point solvent and a low-boiling-point solvent in a dilution ratio of 150 to 500%, and then adding from 5 to 10 parts by weight of a viscous resin with respect to 100 parts by weight of resin content in the metallic coating base agent.

However, the appearance formed by the metallic coating material does not have satisfactory metallic luster.

In addition, coating is required to protect a material in addition to imparting good appearance, and thus excellent coating performance such as high adhesiveness is needed.

### CITATION LIST

### Patent Literature

Patent Document 1: JP 63-272544 A
Patent Document 2: JP 2003-313500 A

### SUMMARY OF INVENTION

### Technical Problem

An object of the present invention is to provide a multilayer coating film-forming method whereby a multilayer coating film that has excellent metallic luster and excellent coating performance can be formed.

### Solution to Problem

The present invention encompasses the subject matter described in the following items.

Aspect 1 A multilayer coating film-forming method including:
(1) applying a photoluminescent coating material composition (Y) onto an object to be coated to form a photoluminescent coating film;
(2) applying a clear coating material composition (Z) containing a hydroxyl group-containing resin (z1) and a polyisocyanate compound (z2) onto the photoluminescent coating film produced in (1) to form a clear coating film; and
(3) heating, separately or simultaneously, the photoluminescent coating film formed in (1) and the clear coating film formed in (2) to cure the photoluminescent coating film and the clear coating film, the photoluminescent coating material composition (Y) containing an indium particle (y1), a surface conditioner (y2), and an organic solvent (y3), and a solid content of the photoluminescent coating material composition (Y) being from 0.1 to 15 mass %.

Aspect 2 The multilayer coating film-forming method according to Aspect 1, where the photoluminescent coating material composition (Y) contains the indium particle (y1) in an amount of 70 parts by mass or greater with respect to 100 parts by mass of the total amount of the solid content of the photoluminescent coating material composition (Y).

Aspect 3 The multilayer coating film-forming method according to Aspect 1 or 2, where the surface conditioner (y2) contains a fluorine-based surface conditioner.

Aspect 4 The multilayer coating film-forming method according to any one of Aspects 1 to 3, where the organic solvent (y3) contains at least one type of solvent selected from the group consisting of an alcohol-based solvent and a glycol ether-based solvent.

### Advantageous Effects of Invention

According to the multilayer coating film-forming method of an embodiment of the present invention, a multilayer coating film that has excellent metallic luster and excellent coating performance such as adhesiveness can be formed.

### DESCRIPTION OF EMBODIMENTS

The multilayer coating film-forming method according to an embodiment of the present invention includes:
(1) applying a photoluminescent coating material composition (Y) onto an object to be coated to form a photoluminescent coating film;
(2) applying a clear coating material composition (Z) containing a hydroxyl group-containing resin (z1) and a polyisocyanate compound (z2) onto the photoluminescent coating film produced in (1) to form a clear coating film; and
(3) heating, separately or simultaneously, the photoluminescent coating film formed in (1) and the clear coating film formed in (2) to cure the photoluminescent coating film and the clear coating film,
the photoluminescent coating material composition (Y) containing an indium particle (y1), a surface conditioner (y2), and an organic solvent (y3), and a solid content of the photoluminescent coating material composition (Y) being from 0.1 to 15 mass %.

### Step (1)

According to the multilayer coating film-forming method of an embodiment of the present invention, first, a photoluminescent coating material composition (Y) is applied on an object to be coated, and a photoluminescent coating film is formed.

### Object To Be Coated

The object to be coated to which the photoluminescent coating material composition (Y) is applied is not particularly limited. Examples of the object to be coated include outer panel parts of automobile bodies, such as those of passenger cars, trucks, motorcycles, and buses; automobile parts such as bumpers; outer panel parts of home electrical appliances, such as mobile phones and audio devices. In particular, outer panel parts of automobile bodies and automobile parts are preferred.

Materials of these objects to be coated are not particularly limited. Examples include metal materials, such as iron, aluminum, brass, copper, tin plates, stainless steel, galvanized steel, and zinc alloy (such as Zn—Al, Zn—Ni, and Zn—Fe)-plated steel; resins, such as polyethylene resins, polypropylene resins, acrylonitrile-butadiene-styrene (ABS) resins, polyamide resins, acrylic resins, vinylidene chloride resins, polycarbonate resins, polyurethane resins, and epoxy resins; plastic materials, such as various FRPs; inorganic materials, such as glass, cement, and concrete; woods; and fiber materials, such as paper and cloth. In particular, a metal material and a plastic material are preferred.

A surface of the object to be coated to which the multilayer coating film is applied may be a metal surface of, for example, outer panel parts of automobile bodies, automobile parts, home electronics, metal substrates such as steel sheets and the like constituting the foregoing, that has undergone optionally chosen surface treatment, such as phosphate salt treatment, chromate treatment, or composite oxide treatment.

A coating film may be further formed on an object to be coated that may or may not be surface-treated. For example, an object to be coated, which is a substrate, may be surface-treated as necessary, and an undercoating film and/or an intermediate coating film may be formed on the treated surface. For example, when the object to be coated is an automobile body, the undercoating film and/or the intermediate coating film can be formed using coating material compositions for undercoating and/or intermediate coating that are per se known and typically used in coating automobile bodies.

For example, an electrodeposition paint, preferably a cationic electrodeposition paint, can be used as the undercoating material composition to form the undercoating film. In addition, a coating material that can be used as the intermediate coating material composition for forming the intermediate coating film includes a coating material prepared using a base resin having a cross-linking functional group such as a carboxyl group or a hydroxyl group, such as an acrylic resin, a polyester resin, an alkyd resin, a urethane resin, or an epoxy resin; and a crosslinking agent, such as an amino resin such as a melamine resin or a urea resin, or a polyisocyanate compound that may be blocked; together with a pigment, a thickener, and an optional additional component.

### Photoluminescent Coating Material Composition (Y)

The photoluminescent coating material composition (Y) contains an indium particle (y1), a surface conditioner (y2), and an organic solvent (y3), and having a solid content of 0.1 to 15 mass %.

### Indium Particle (y1)

The indium particle (y1) is a flaky particle. The flaky particle may be also referred to as a scale-like particle, a sheet-like particle, or a flake-like particle.

In an embodiment of the present invention, a flaky particle means a particle having a substantially flat surface and a thickness in a direction perpendicular to the substantially flat surface is substantially uniform. Furthermore, the flaky particle means a particle with a shape, in which the thickness is extremely thin and a length of the substantially flat surface is extremely long. Note that the length of the substantially flat surface is a diameter of a circle having a projected area that is the same as a projected area of the flaky particle.

The shape of the substantially flat surface is not particularly limited and can be selected appropriately based on the purpose. Examples of the shape include a polygon such as a substantially rectangular, substantially square, substantially circular, substantially elliptical, substantially triangular, substantially quadrilateral, substantially pentagonal, substantially hexagonal, substantially heptagonal, or substantially octagonal shape, and a random irregular shape. Among these, a substantially circular shape is preferred.

The indium particles (y1) may form one layer or may form a primary particle with two or more layers layered therein. Furthermore, primary particles of the indium particles (y1) may aggregate to form a secondary particle.

Note that the indium particle (y1) is made of indium with a purity of 95% or greater, and may contain a trace amount of impurities but does not contain an alloy with another metal.

The indium particle (y1) can be produced by performing release layer formation, vacuum deposition, releasing, and, as necessary, another process.

### Release Layer Formation

Release layer formation is a process of providing a release layer on a substrate.

The substrate is not particularly limited as long as the substrate has a smooth surface, and various substrates can be used. Among these, a resin film, metal foil, or composite film of a metal foil and a resin film, having flexibility, heat resistance, solvent resistance, and dimensional stability can be suitably used. Examples of the resin film include a polyester film, a polyethylene film, a polypropylene film, a polystyrene film, and a polyimide film. Examples of the metal foil include copper foil, aluminum foil, nickel foil, iron foil, and alloy foil. Examples of the composite film of a metal foil and a resin film include a composite film produced by laminating the resin film and the metal foil described above.

As the release layer, various organic materials that can be dissolved in the releasing described below can be used. Furthermore, when the organic material constituting the release layer is appropriately selected, an organic material attached to and remained on an attachment face of island structure film can function as a protective layer of the indium particle (y1), which is preferable.

The protective layer has a function of suppressing aggregation of the indium particle (y1), oxidation of the indium particle (y1), flowing out of the indium particle (y1) into a solvent, and the like. In particular, using the organic material used for the release layer as a protective layer is preferred because surface treatment is not required to be additionally performed.

Examples of the organic material constituting the release layer that can be used as a protective layer include cellulose acetate butyrate (CAB) and other cellulose derivatives, polyvinyl alcohol, polyvinyl butyral, polyethylene glycol, polyacrylic acid, polyacrylamide, polyvinyl butyral, an acrylic acid copolymer, a modified nylon resin, polyvinylpyrrolidone, a urethane resin, a polyester resin, a polyether resin, and an alkyd resin. These may be used alone or in a combination of two or more types thereof. Among these, from the viewpoint of high functionality as a protective layer, cellulose acetate butyrate (CAB) is preferred.

The forming method of the release layer is not particularly limited and can be appropriately selected based on the purpose. Examples of the method include an inkjet method, a blade coating method, a gravure coating method, a gravure offset coating method, a bar coating method, a roll coating method, a knife coating method, an air knife coating method, a comma coating method, a U comma coating method, an AKKU coating method, a smoothing coating method, a micro-gravure coating method, a reverse roll coating method, a four-roll coating method, a five-roll coating method, a dip coating method, a curtain coating method, a slide coating method, and a die coating method. These may be used alone or in a combination of two or more types thereof.

### Vacuum Deposition

The vacuum deposition is a process of performing vacuum deposition of a metal layer containing an indium particle (y1) onto the release layer.

The average vapor deposition thickness of the metal layer containing the indium particle (y1) is preferably 60 nm or less, more preferably 55 nm or less, even more preferably 50 nm or less, and particularly preferably 45 nm or less. Note that the average vapor deposition thickness of the metal layer containing the indium particle (y1) is the same as the average thickness of the indium particle (y1).

When the average vapor deposition thickness of the metal layer is 60 nm or less, a surface roughness Ra of the coating film decreases, and excellent metallic luster can be exhibited, which is a benefit. The average vapor deposition thickness is determined by, for example, observing a cross-section of a metal layer, measuring thicknesses at 5 to 10 positions of the metal layer by using a scanning electron microscope (SEM), and averaging the measured thicknesses.

The metal layer is preferably an island structure film. The island structure film can be formed by various methods such as a vacuum deposition method, a sputtering method, and a plating method. Among these, a vacuum deposition method is preferred.

The vacuum deposition method is more preferred than the plating method from the viewpoints of being capable of forming a film on a resin substrate, generating no waste fluid, and the like, and is more preferred than the sputtering method from the viewpoints of being capable of setting a degree of vacuum high and achieving a high film formation rate (vapor deposition rate) and the like.

The vapor deposition rate in the vacuum deposition method is preferably 10 nm/see or faster, and more preferably 10 nm/see or faster and 80 nm/see or slower.

### Releasing

The releasing is a process of releasing the metal layer by dissolving the release layer. The solvent that can dissolve the release layer is not particularly limited as long as the solvent is a solvent that can dissolve the release layer, and can be appropriately selected based on the purpose; however, the solvent is preferably a solvent that can be used as is as a solvent for the photoluminescent coating material composition (Y).

Examples of the solvent that can dissolve the release layer include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. These may be used alone or in a combination of two or more types thereof.

By dissolving the release layer, the island structure film is released from the substrate, then the island structure film breaks up, and each island becomes an indium particle (y1). As a result, an indium particle (y1) dispersion liquid is produced particularly without performing crushing; however, as necessary, pulverization and classification may be performed. Furthermore, in a case where primary particles of indium particles (y1) are aggregated, as necessary, such an aggregate may be crushed.

Furthermore, as necessary, various treatments may be performed to recover the indium particle (y1) and to adjust the physical properties of the indium particle (y1). For example, the particle size of the indium particle (y1) may be adjusted by classification, recovery of the indium particle (y1) may be performed by a method such as centrifugal separation or suction filtration, and adjustment of a solid concentration of the dispersion liquid may be performed. In addition, solvent substitution may be performed, and viscosity adjustment and the like may be performed by using an additive.

### Other Processes

Examples of other processes include a process of taking out the released metal layer as a dispersion liquid, a process of recovering the island-like metal layer as the indium particle (y1) from the dispersion liquid, and the like.

From the viewpoint of forming a multilayer coating film having excellent metallic luster, a 50% cumulative volumetric particle size D50 of the indium particles (y1) produced by performing the release layer formation, the vacuum deposition, the releasing, and optional other processes is preferably 0.70 μm or less, more preferably 0.60 μm or less, even more preferably 0.50 μm or less, and particularly preferably 0.40 μm or less.

The indium particle (y1) may be a commercially available product. Examples of the commercially available product include “LeafPowder 49CJ-1120”, “LeafPowder 49CJ-1150”, “LeafPowder 49BJ-1120”, and “LeafPowder 49BJ-1150” (available from Oike & Co., Ltd.).

From the viewpoint of producing a coating film having excellent metallic luster, the photoluminescent coating material composition (Y) of an embodiment of the present invention contains the indium particle (y1) in an amount of preferably 70 parts by mass or greater, more preferably 80 parts by mass or greater, and preferably 90 or greater, with respect to 100 parts by mass of the solid content of the photoluminescent coating material composition (Y). The upper limit of the amount of indium particle (y1) is preferably 99.9 parts by mass or less, and may be 99 parts by mass or less. The amount of indium particle (y1) is even more preferably in a range from 90 to 99.9 parts by mass, and particularly preferably in a range from 95 to 99.9 parts by mass.

### Surface Conditioner (y2)

The surface conditioner (y2) is used as support for allowing the indium particles (y1) to be oriented uniformly on an object to be coated during application of the photoluminescent coating material composition (Y) to the object to be coated.

Examples of the surface conditioner (y2) include a surface conditioner such as a silicone-based surface conditioner, an acrylic surface conditioner, a vinyl-based surface conditioner, and a fluorine-based surface conditioner. Among these, from the viewpoint of producing a coating film having excellent metallic luster, the photoluminescent coating material composition (Y) preferably contains a fluorine-based surface conditioner. The surface conditioners can be used alone or in appropriate combination of two or more.

Examples of the fluorine-based surface conditioner include a fluorine-based polymer and a fluorine-based oligomer, which contain a perfluoroalkyl group and a polyalkylene oxide group; and a fluorine-based polymer and a fluorine-based oligomer, which contain a perfluoroalkyl ether group and a polyalkylene oxide group.

Examples of the commercially available product of the fluorine-based surface conditioner include “LE-604” and “LE-605” (available from Kyoeisha Chemical Co., Ltd.), and “F-444” and “F-554” (available from DIC Corporation).

From the viewpoints of producing a coating film having excellent metallic luster, the content of the surface conditioner (y2) in the photoluminescent coating material composition (Y) of an embodiment of the present invention is preferably from 0.001 to 1 part by mass, more preferably from 0.003 to 0.5 parts by mass, and even more preferably from 0.005 to 0.3 parts by mass, with respect to 100 parts by mass of the solid content of the photoluminescent coating material composition (Y).

### Organic Solvent (y3)

As the organic solvent (y3) in the photoluminescent coating material composition (Y) of an embodiment of the present invention, an organic solvent that is typically used for a coating material can be used. Specific examples thereof include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. These may be used alone or in a combination of two or more types thereof.

From the viewpoint of producing a coating film having excellent metallic luster, as the organic solvent (y3), the photoluminescent coating material composition (Y) contains preferably at least one type of solvent selected from the group consisting of a glycol ether-based organic solvent and an alcohol-based organic solvent, and more preferably a glycol ether-based organic solvent.

From the viewpoint of producing a coating film having excellent metallic luster, the content of the organic solvent (y3) in the photoluminescent coating material composition (Y) of an embodiment of the present invention is preferably in a range from 85 to 99.9 parts by mass, more preferably from 90 to 99.5 parts by mass, and even more preferably in a range from 95 to 99 parts by mass, with respect to 100 parts by mass of the total of all components of the photoluminescent coating material composition (Y).

The solid content of the photoluminescent coating material composition (Y) of an embodiment of the present invention is from 0.1 to 15 mass %. In particular, from the viewpoint of producing a coating film having excellent metallic luster, the solid content of the photoluminescent coating material composition (Y) is preferably in a range from 0.5 to 10 mass %, and more preferably in a range from 1 to 5 mass %.

### Additional Component

As necessary, the photoluminescent coating material composition (Y) may further appropriately contain a pigment other than the indium particle (y1), a viscosity modifier, a binder resin, a cross-linking component, a pigment dispersant, an anti-settling agent, an ultraviolet absorber, a light stabilizer, and the like.

Examples of the pigment other than the indium particle (y1) include a color pigment, a photoluminescent pigment other than the indium particle (y1), and an extender pigment. The pigments can be used alone or in combination of two or more. Examples of the color pigment include titanium oxide, zinc oxide, carbon black, molybdenum red, Prussian blue, cobalt blue, azo-based pigments, phthalocyanine-based pigments, quinacridone-based pigments, isoindoline-based pigments, threne-based pigments, perylene-based pigments, dioxazine-based pigments, and diketopyrrolopyrrole-based pigments. Examples of the photoluminescent pigment other than the indium particle (y1) include a vapor-deposited metal flake pigment other than the indium particle (y1), an aluminum flake pigment, and a light interference pigment. Examples of the extender pigment include clay, kaolin, barium sulfate, barium carbonate, calcium carbonate, talc, silica, and alumina white.

In a case where the photoluminescent coating material composition (Y) of an embodiment of the present invention contains a pigment other than the indium particle (y1), from the viewpoint of producing a coating film having excellent metallic luster, the content thereof is preferably in a range from 0.01 to 30 parts by mass, more preferably in a range from 0.05 to 20 parts by mass, and even more preferably in a range from 0.1 to 15 parts by mass, with respect to 100 parts by mass of the solid content of the photoluminescent coating material composition (Y).

Examples of the viscosity modifier include a silica-based fine powder, a mineral-based viscosity modifier, a barium sulfate micronized powder, a polyamide-based viscosity modifier, an organic resin particulate viscosity modifier, a diurea-based viscosity modifier, a urethane-associative viscosity modifier, a poly(acrylic acid)-based viscosity modifier that is acrylic swelling-type, and a cellulose-based viscosity modifier.

Examples of the binder resin include an acrylic resin, a polyester resin, an alkyd resin, and a urethane resin.

Examples of the cross-linking component include a melamine resin, a melamine resin derivative, a urea resin, (meth)acrylamide, polyaziridine, polycarbodiimide, and a blocked or unblocked polyisocyanate compound.

Application of the photoluminescent coating material composition (Y) can be performed in accordance with an ordinary method. Examples thereof include air spray coating, airless spray coating, and rotary atomization coating In a case where the photoluminescent coating material composition (Y) is applied, an electrostatic voltage may be applied as necessary and, in particular, electrostatic coating by rotary atomization and electrostatic coating by air spraying are preferred, and electrostatic coating by rotary atomization is particularly preferred.

In addition, when the photoluminescent coating material composition (Y) is applied by air spray coating, airless spray coating, or rotary atomization coating, the photoluminescent coating material composition (Y) preferably appropriately contains water and/or an organic solvent as well as an additive, such as a defoamer, as necessary to adjust the solid content and viscosity to be suitable for coating.

Furthermore, from the viewpoint of producing a multilayer coating film having excellent metallic luster and the like, the viscosity of the photoluminescent coating material composition (Y) is preferably approximately from 8 to 30 seconds, and more preferably approximately from 10 to 25 seconds, at 20° C. determined by Ford viscosity cup No. 3.

Furthermore, from the viewpoint of producing a multilayer coating film having excellent metallic luster and the like, the cured film thickness of the photoluminescent coating film is preferably approximately from 0.01 to 2 μm, more preferably from 0.025 to 1 μm, and even more preferably approximately from 0.05 to 0.5 μm.

### Step (2)

According to the multilayer coating film-forming method of an embodiment of the present invention, next, a clear coating material composition (Z) containing a hydroxyl group-containing resin (z1) and a polyisocyanate compound (z2) is applied on the photoluminescent coating film produced in Step (1), and thus a clear coating film is formed.

The hydroxyl group-containing resin (z1) is a resin having at least one hydroxyl group per molecule. Examples of the hydroxyl group-containing resin (z1) include a resin such as an acrylic resin having a hydroxyl group, a polyester resin having a hydroxyl group, a polyurethane resin having a hydroxyl group, a polyolefin resin having a hydroxyl group, a polyether resin having a hydroxyl group, a polycarbonate resin having a hydroxyl group, an epoxy resin having a hydroxyl group, and an alkyd resin having a hydroxyl group. These resins can each be used alone, or two or more types of these resins can be combined and used.

From the viewpoint of adhesiveness of the resulting multilayer coating film and the like, as the hydroxyl group-containing resin (z1), a hydroxyl group-containing acrylic resin (z11) is preferably used.

Hydroxyl Group-Containing Acrylic Resin (z11)

The hydroxyl group-containing acrylic resin (z11) can be produced, for example, by copolymerizing a polymerizable unsaturated monomer that can be copolymerized with a hydroxyl group-containing polymerizable unsaturated monomer and the hydroxyl group-containing polymerizable unsaturated monomer by a method known per se, such as a solution polymerization method in an organic solvent or an emulsion polymerization method in water.

The hydroxyl group-containing polymerizable unsaturated monomer is a compound having one or more hydroxyl groups and one or more polymerizable unsaturated bonds per molecule. Examples of the hydroxyl group-containing polymerizable unsaturated monomer include monoesterified products of a (meth)acrylic acid and a dihydric alcohol having from 2 to 8 carbons, such as 2-hydroxyethyl (meth)acrylate, 2-hydroxypropyl (meth)acrylate, 3-hydroxypropyl (meth)acrylate, and 4-hydroxybutyl (meth)acrylate; ¿-caprolactone modified products of these monoesterified products of a (meth)acrylic acid and a dihydric alcohol having from 2 to 8 carbons; N-hydroxymethyl (meth)acrylamide; allyl alcohols; and (meth)acrylates having a polyoxyethylene chain with a hydroxyl group at the molecular terminal. However, in an embodiment of the present invention, the monomer corresponding to (xvii) a polymerizable unsaturated monomer having a UV absorbing functional group described below should be defined as a polymerizable unsaturated monomer that can be copolymerized with the hydroxyl group-containing polymerizable unsaturated monomer and is excluded from the hydroxyl group-containing polymerizable unsaturated monomer. The hydroxyl group-containing polymerizable unsaturated monomer can be each used alone or in combination of two or more.

As the polymerizable unsaturated monomer that can be copolymerized with the hydroxyl group-containing polymerizable unsaturated monomer, for example, monomers described in the following (i) to (xx) can be used. These polymerizable unsaturated monomers can be each used alone or in combination in two or more.
(i) Alkyl or cycloalkyl (meth)acrylates: such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl(meth)acrylate, n-octyl (meth)acrylate, 2-ethylhexyl (meth)acrylate, nonyl(meth)acrylate, tridecyl(meth)acrylate, lauryl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, and tricyclodecanyl(meth)acrylate.
(ii) Polymerizable unsaturated monomers having an isobornyl group: such as isobornyl (meth)acrylate.
(iii) Polymerizable unsaturated monomers having an adamantyl group: such as adamantyl (meth)acrylate.
(iv) Polymerizable unsaturated monomers having a tricyclodecenyl group: such as tricyclodecenyl(meth)acrylate.
(v) Aromatic ring-containing polymerizable unsaturated monomers: such as benzyl (meth)acrylate, styrene, α-methylstyrene, and vinyl toluene.
(vi) Polymerizable unsaturated monomers having an alkoxysilyl group: such as vinyltrimethoxysilane, vinyltriethoxysilane, vinyltris(2-methoxyethoxy)silane, y-(meth)acryloyloxypropyltrimethoxysilane, and y-(meth)acryloyloxypropyltriethoxysilane.
(vii) Polymerizable unsaturated monomers having a fluorinated alkyl group: such as perfluoroalkyl (meth)acrylates such as perfluorobutylethyl (meth)acrylate and perfluorooctylethyl (meth)acrylate; and fluoroolefins.
(viii) Polymerizable unsaturated monomers having a photopolymerizable functional group: such as a maleimide group.
(ix) Vinyl compounds: such as N-vinylpyrrolidone, ethylene, butadiene, chloroprene, vinyl propionate, and vinyl acetate.
(x) Carboxyl group-containing polymerizable unsaturated monomers: such as (meth)acrylic acid, maleic acid, crotonic acid, and β-carboxyethyl (meth)acrylate.
(xi) Nitrogen-containing polymerizable unsaturated monomers: such as (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylene bis(meth)acrylamide, ethylene bis(meth)acrylamide, and adducts of glycidyl (meth)acrylate and amine compounds.
(xii) Polymerizable unsaturated monomers having two or more polymerizable unsaturated groups per molecule: such as allyl(meth)acrylate, ethylene glycol di(meth)acrylate, 1,4-butanediol di(meth)acrylate, neopentyl glycol di(meth)acrylate, and 1,6-hexanediol di(meth)acrylate.
(xiii) Epoxy group-containing polymerizable unsaturated monomers: such as glycidyl (meth)acrylate, ß-methylglycidyl (meth)acrylate, 3,4-epoxycyclohexyl methyl(meth)acrylate, 3,4-epoxycyclohexyl ethyl(meth)acrylate, 3,4-epoxycyclohexylpropyl (meth)acrylate, and allyl glycidyl ether.
(xiv) (Meth)acrylates having a polyoxyethylene chain with an alkoxy group at the molecular terminal.
(xv) Polymerizable unsaturated monomers having a sulfonic acid group: such as 2-acrylamido-2-methylpropane sulfonic acid, 2-sulfoethyl(meth)acrylate, allyl sulfonic acid, 4-styrene sulfonic acid, and sodium salts and ammonium salts of these sulfonic acids.
(xvi) Polymerizable unsaturated monomers having a phosphate group: such as acid phosphoxyethyl (meth)acrylate, acid phosphoxypropyl (meth)acrylate, acid phosphoxypoly(oxyethylene)glycol (meth)acrylate, and acid phosphoxypoly(oxypropylene)glycol (meth)acrylate.
(xvii) Polymerizable unsaturated monomers having a UV-absorbing functional group: such as 2-hydroxy-4(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-[2-hydroxy-5-[2-(methacryloyloxy)ethyl]phenyl]-2H-benzotriazole.
(xviii) Photostable polymerizable unsaturated monomers: such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine.
(xix) Polymerizable unsaturated monomers having a carbonyl group: such as acrolein, diacetone acrylamide, diacetone methacrylamide, acetoacetoxy ethyl methacrylate, formylstyrol, and vinyl alkyl ketones having from 4 to 7 carbons (for example, vinyl methyl ketone, vinyl ethyl ketone, and vinyl butyl ketone).
(xx) Polymerizable unsaturated monomers having an acid anhydride group: such as maleic anhydride, itaconic anhydride, and citraconic anhydride.

In the present specification, a polymerizable unsaturated group means an unsaturated group that is radically polymerizable. Examples of such polymerizable unsaturated groups include a vinyl group and a (meth)acryloyl group.

In addition, in the present specification, “(meth)acrylate” means an acrylate or a methacrylate. “(Meth)acrylic acid” means acrylic acid or methacrylic acid. “(Meth)acryloyl” means acryloyl or methacryloyl. “(Meth)acrylamide” means acrylamide or methacrylamide.

From the viewpoints of water resistance, finished appearance, and the like of the resulting coating film, the content of the hydroxyl group-containing acrylic resin (z11) in the clear coating material composition (Z) is preferably in a range from 20 to 80 parts by mass, more preferably in a range from 25 to 75 parts by mass, and even more preferably in a range from 30 to 70 parts by mass, with respect to 100 parts by mass of the resin solid content of the clear coating material composition (Z).

From the viewpoints of adhesiveness, chipping resistance, finished appearance, and the like of the resulting multilayer coating film, the used amount of the hydroxyl group-containing polymerizable unsaturated monomer in the production of the hydroxyl group-containing acrylic resin (z11) is preferably in a range from 15 to 50 mass %, and preferably 20 to 40 mass %, with respect to the total amount of the copolymerizable monomer component.

From the viewpoints of adhesiveness, chipping resistance, finished appearance, and the like of the resulting multilayer coating film, the hydroxyl value of the hydroxyl group-containing acrylic resin (z11) is preferably in a range from 50 to 210 mg KOH/g, more preferably in a range from 80 to 200 mg KOH/g, and even more preferably in a range from 100 to 170 mg KOH/g.

From the viewpoints of adhesiveness, chipping resistance, finished appearance, and the like of the resulting multilayer coating film, the weight average molecular weight of the hydroxyl group-containing acrylic resin (z11) is preferably in a range from 2000 to 50000, more preferably in a range from 3000 to 30000, and even more preferably in a range from 4000 to 10000.

From the viewpoints of finished appearance and adhesiveness of the resulting multilayer coating film, pot life of the clear coating material composition (Z), and the like, the acid value of the hydroxyl group-containing acrylic resin (z11) is preferably in a range of 30 mg KOH/g or less, and more preferably in a range from 1 to 20 mg KOH/g.

From the viewpoints of adhesiveness, chipping resistance, finished appearance, and the like of the resulting multilayer coating film, the glass transition temperature of the hydroxyl group-containing acrylic resin (z11) is preferably in a range from-50 to 60° C., more preferably in a range from 10 to 50° C., and even more preferably in a range from 20 to 45° C.

In the present specification, the glass transition temperature (° C.) of the acrylic resin is calculated by the following equations.

$$1 / Tg ( K ) = ( W 1 / T 1 ) + ( W 2 / T 2 ) + \qquad ( 1 )$$

$$Tg ( ° C . ) = T g ( K ) - 273 \qquad ( 2 )$$

In the equations, W1, W2, and so on are the mass fractions of the monomers used for copolymerization, and T1, T2, and so on are the Tg (K) of the homopolymers of the monomers. Note that, T1, T2, and so on are values according to Polymer Handbook (Second Edition, J.Brandup, E. H. Immergut, ed.) III, pp. 139-179. The glass transition temperature (° C.) used for cases where a Tg of a homopolymer of a monomer is unknown is assumed to be the static glass transition temperature, which is provided as follows. A sample is placed into a measuring cup of a differential scanning calorimeter “DSC-220U” (available from Seiko Instruments, Inc.), and vacuum suction is performed to completely remove the solvent; then, the change in heat quantity is measured in a range from −20° C. to +200° C. at a temperature increase rate of 3° C./min, and the change point of the initial baseline at the low-temperature end is recorded as the static glass transition temperature.

As a copolymerization method for producing the hydroxyl group-containing acrylic resin (z11) by copolymerizing the polymerizable unsaturated monomer mixture, it is possible to suitably use a solution polymerization method in which polymerization is performed in an organic solvent in the presence of a polymerization initiator.

Examples of the organic solvent that is used during the solution polymerization method include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; and an aliphatic or aromatic chlorinated hydrocarbon-based solvent such as dichloromethane, chloroform, trichloroethane, chlorobenzene, and dichlorobenzene.

Examples of the polymerization initiator that can be used in the copolymerization of the hydroxyl group-containing acrylic resin (z11) include known radical polymerization initiators such as 2,2′-azobisisobutyronitrile, benzoyl peroxide, di-t-butyl peroxide, di-t-amyl peroxide, t-butyl peroctoate, 2,2′-azobis(2-methylbutyronitrile), and 2,2′-azobis(2,4-dimethylvaleronitrile). The hydroxyl group-containing acrylic resins (z11) may be used alone or in combination of two or more thereof.

### Polyisocyanate Compound (z2)

The polyisocyanate compound (z2) is a compound having at least two isocyanate groups per molecule, and examples thereof include an aliphatic polyisocyanate, an alicyclic polyisocyanate, an aromatic-aliphatic polyisocyanate, an aromatic polyisocyanate, and a derivative of the polyisocyanate.

Examples of the aliphatic polyisocyanates include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4-or 2,2,4-trimethylhexamethylene diisocyanate, dimer acid diisocyanate, and methyl 2,6-diisocyanatohexanoate (common name: lysine diisocyanate); and aliphatic triisocyanates, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanates include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or its mixture, methylenebis(4,1-cyclohexanediyl)diisocyanate (common name: hydrogenated MDI), and norbornane diisocyanate; and alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, and 6-(2-isocyanatoethyl)-2-isocyanatomethyl-2-(3-isocyanatopropyl)-bicyclo(2.2.1)heptane.

Examples of the aromatic-aliphatic polyisocyanates include aromatic-aliphatic diisocyanates, such as methylenebis(4,1-phenylene)diisocyanate (common name: MDI), 1,3- or 1,4-xylylene diisocyanate or its mixture, @, @′-diisocyanato-1,4-diethylbenzene, and 1,3- or 1,4-bis(1-isocyanato-1-methylethyl)benzene (common name: tetramethylxylylene diisocyanate) or its mixture; and aromatic-aliphatic triisocyanates, such as 1,3,5-triisocyanatomethylbenzene.

Examples of the aromatic polyisocyanates include aromatic diisocyanates, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI) or 2,6-tolylene diisocyanate (common name: 2,6-TDI) or its mixture, 4,4′-toluidine diisocyanate, and 4,4′-diphenyl ether diisocyanate; aromatic triisocyanates, such as triphenylmethane-4,4′,4″-triisocyanate, 1,3,5-triisocyanatobenzene, and 2,4,6-triisocyanatotoluene; and aromatic tetraisocyanates, such as 4,4′-diphenylmethane-2,2′,5,5′-tetraisocyanate.

In addition, examples of the derivatives of the polyisocyanates include dimers, trimers, biuret, allophanate, uretdione, uretoimine, isocyanurates, oxadiazinetrione, and polymethylene polyphenyl polyisocyanates (crude MDI and polymeric MDI), and crude TDI of the polyisocyanates described above.

The polyisocyanates and their derivatives may each be used alone or in combination of two or more.

Examples that can be suitably used include hexamethylene diisocyanate-based compounds among the aliphatic diisocyanates and 4,4′-methylenebis(cyclohexyl isocyanate) among the alicyclic diisocyanates. Among these, a derivative of hexamethylene diisocyanate is optimal from the viewpoint of adherence and compatibility.

In addition, examples of the polyisocyanate compound (z2) that may be used include prepolymers formed by reacting the polyisocyanate or its derivative described above with a compound having an active hydrogen group, such as a hydroxyl group or an amino group, which can react with the polyisocyanate, under conditions of excess isocyanate groups. Examples of the compound that can react with the polyisocyanate include polyhydric alcohols, low molecular weight polyester resins, amines, and water.

In addition, examples of the polyisocyanate compound (z2) also include blocked polyisocyanate compounds, which are compounds formed by blocking an isocyanate group in the polyisocyanate and its derivative with a blocking agent.

Examples of the blocking agent include phenolic compounds, such as phenol, cresol, xylenol, nitrophenol, ethylphenol, hydroxydiphenyl, butylphenol, isopropylphenol, nonylphenol, octylphenol, and methyl hydroxybenzoate; lactam-based compounds, such as &-caprolactam, 8-valerolactam, γ-butyrolactam, and ß-propiolactam; aliphatic alcohol-based compounds, such as methanol, ethanol, propyl alcohol, butyl alcohol, amyl alcohol, and lauryl alcohol; ether-based compounds, such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol-based compounds, such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime-based compounds, such as formamide oxime, acetoamide oxime, acetoxime, methyl ethyl ketoxime, diacetyl monoxime, benzophenone oxime, and cyclohexane oxime; active methylene-based compounds, such as dimethyl malonate, diethyl malonate, ethyl acetoacetate, methyl acetoacetate, and acetylacetone; mercaptan-based compounds, such as butyl mercaptan, t-butyl mercaptan, hexyl mercaptan, t-dodecyl mercaptan, 2-mercaptobenzothiazole, thiophenol, methylthiophenol, and ethylthiophenol; acid amide-based compounds, such as acetanilide, acetanisidide, acetotoluide, acrylamide, methacrylamide, acetic amide, stearic amide, and benzamide; imide-based compounds, such as succinimide, phthalimide, and maleimide; amine-based compounds, such as diphenylamine, phenylnaphthylamine, xylidine, N-phenylxylidine, carbazole, aniline, naphthylamine, butylamine, dibutylamine, and butylphenylamine; imidazole-based compounds, such as imidazole and 2-ethylimidazole; urea-based compounds, such as urea, thiourea, ethyleneurea, ethylenethiourea, and diphenylurea; carbamic ester-based compounds, such as phenyl N-phenylcarbamate; imine-based compounds, such as ethyleneimine and propyleneimine; sulfite-based compounds, such as sodium bisulfite and potassium bisulfite; and azole-based compounds. Examples of the azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; and imidazoline derivatives, such as 2-methylimidazoline and 2-phenylimidazoline.

When an isocyanate group of the polyisocyanate compound is blocked (the polyisocyanate compound is reacted with a blocking agent), a solvent can be added as necessary.

The polyisocyanate compound (z2) can be used alone or in combination of two or more.

The equivalent ratio (NCO/OH) of the isocyanate group in the polyisocyanate compound (z2) to the hydroxyl group in the hydroxyl group-containing resin (z1) in the clear coating material composition (Z) is preferably in a range from 0.5 to 2.0, and more preferably in a range from 0.8 to 1.5.

The clear coating material composition (Z) can appropriately contain as necessary a solvent, such as water or an organic solvent; or an additive for a coating material, such as a curing catalyst, a defoamer, an ultraviolet absorber, a rheology control agent, and an antisettling agent.

The clear coating material composition (Z) can appropriately contain a color pigment in a range that does not impair the transparency of the coating film. As the color pigment, a pigment known for an ink or for a coating material can be used alone, or two or more types of such pigments can be used in combination. The blended amount thereof differs based on the type and the like of the color pigment to be used, and the blended amount is preferably 30 mass % or less, more preferably in a range from 0.05 to 20 mass %, and even more preferably in a range from 0.1 to 10 mass %, with respect to the total amount of the solid content of the resin component of the clear coating material composition (Z).

The clear coating material composition (Z) can be applied by a method, such as electrostatic coating, air spraying, or airless spraying, and the film thickness of the clear coating film is, based on the cured coating film, preferably approximately from 10 to 60 μm, more preferably from 15 to 50 μm, and even more preferably approximately from 20 to 40 μm.

The solid content of the clear coating material composition (Z) is preferably in a range from 10 to 65 mass %, more preferably in a range from 15 to 55 mass %, and even more preferably in a range from 20 to 50 mass %. Furthermore, the viscosity of the clear coating material composition (Z) is typically appropriately adjusted to a range suitable for application, which is preferably approximately 15 to 60 seconds, and more preferably approximately 20 to 50 seconds, at 20° C. determined by Ford viscosity cup No. 4, by using water and/or an organic solvent.

### Step (3)

According to the multilayer coating film-forming method of an embodiment of the present invention, then the photoluminescent coating film formed in (1) above and the clear coating film formed in (2) above are heated separately or simultaneously to cure the coating films.

The heating can be implemented, for example, by a means such as hot air heating, infrared heating, and high frequency heating. The heating temperature is preferably from 80 to 160° C. and more preferably from 100 to 140° C. Furthermore, the heating time is preferably from 10 to 60 minutes, and more preferably from 15 to 40 minutes. Before performing the above heating and curing, heating may be performed, as necessary, directly or indirectly by preheating, air blowing, or the like at a temperature of preferably approximately 50 to approximately 110° C., and more preferably approximately 60 to approximately 90° C., for approximately 1 to 60 minutes.

The present invention can employ the following configurations.

Aspect 1 A multilayer coating film-forming method including:
(1) applying a photoluminescent coating material composition (Y) onto an object to be coated to form a photoluminescent coating film;
(2) applying a clear coating material composition (Z) containing a hydroxyl group-containing resin (z1) and a polyisocyanate compound (z2) onto the photoluminescent coating film produced in (1) to form a clear coating film; and
(3) heating, separately or simultaneously, the photoluminescent coating film formed in (1) and the clear coating film formed in (2) to cure the photoluminescent coating film and the clear coating film, the photoluminescent coating material composition (Y) containing an indium particle (y1), a surface conditioner (y2), and an organic solvent (y3), and a solid content of the photoluminescent coating material composition (Y) being from 0.1 to 15 mass %.

Aspect 2 The multilayer coating film-forming method according to Aspect 1, where the photoluminescent coating material composition (Y) contains the indium particle (y1) in an amount of 70 parts by mass or greater with respect to 100 parts by mass of the total amount of the solid content of the photoluminescent coating material composition (Y).

Aspect 3 The multilayer coating film-forming method according to Aspect 1, where the photoluminescent coating material composition (Y) contains the indium particle (y1) in an amount of 90 to 99.9 parts by mass with respect to 100 parts by mass of the total amount of the solid content of the photoluminescent coating material composition (Y).

Aspect 4 The multilayer coating film-forming method according to any one of Aspects 1 to 3, where the surface conditioner (y2) contains a fluorine-based surface conditioner.

Aspect 5 The multilayer coating film-forming method according to any one of Aspects 1 to 4, where the photoluminescent coating material composition (Y) contains the surface conditioner (y2) in an amount of 0.001 to 1 part by mass with respect to 100 parts by mass of the solid content of the photoluminescent coating material composition (Y).

Aspect 6 The multilayer coating film-forming method according to any one of Aspects 1 to 5, where the organic solvent (y3) contains at least one type of solvent selected from the group consisting of an alcohol-based solvent and a glycol ether-based solvent.

Aspect 7 The multilayer coating film-forming method according to any one of Aspects 1 to 6, where the photoluminescent coating material composition (Y) contains the organic solvent (y3) in a range from 85 to 99.9 parts by mass with respect to 100 parts by mass of the total amount of all components of the photoluminescent coating material composition (Y).

Aspect 8 The multilayer coating film-forming method according to any one of Aspects 1 to 7, where the solid content of the photoluminescent coating material composition (Y) is from 0.5 to 10 mass %.

Aspect 9 The multilayer coating film-forming method according to any one of Aspects 1 to 7, where the solid content of the photoluminescent coating material composition (Y) is from 1 to 5 mass %.

Aspect 10 The multilayer coating film-forming method according to any one of Aspects 1 to 9, where the hydroxyl group-containing resin (z1) contains a hydroxyl group-containing acrylic resin (z11).

Aspect 11 The multilayer coating film-forming method according to any one of Aspects 1 to 10, where a cured film thickness of the photoluminescent coating film is from 0.01 to 2 μm.

Aspect 12 The multilayer coating film-forming method according to any one of Aspects 1 to 11, where a cured film thickness of the clear coating film is from 10 to 60 μm. Although embodiments and examples of the present invention have been described in detail above, the present invention is not limited to the embodiments described above and the examples described below, and various modifications are possible based on the technical idea of the present invention.

For example, the configurations, methods, processes, shapes, materials, numerical values, etc., given in the embodiments described above and the examples described below are merely examples, and different configurations, methods, processes, shapes, materials, numerical values, etc., may be used when necessary.

Also, the configurations, methods, processes, shapes, materials, numerical values, etc. of the embodiments described above and the examples described below can be combined with each other without departing from the gist of the present invention.

### EXAMPLES

The present invention will be described more specifically below with reference to examples and comparative examples. However, the present invention is not limited to these examples only. Both “parts” and “%” are based on mass.

### 1. Preparation of Substrate

A cationic electrodeposition paint “Electron GT-10” (trade name, available from Kansai Paint Co., Ltd., a paint in which a block polyisocyanate compound is used as a curing agent in an epoxy resin polyamine-based cation resin) was applied by electrodeposition on a degreased and zinc phosphate-treated steel sheet (JIS G 3141, a size of 400 mm×300 mm×0.8 mm) to give a film thickness of a cured coating film of 20 μm. The paint was cross-linked and cured by heating at 170° C. for 20 minutes, and an electrodeposition coating film was formed.

On the electrodeposition coating surface of the resulting steel sheet, “TP-65-2” (trade name, available from Kansai Paint Co., Ltd.; polyester resin and amino resin-based organic solvent-type intermediate coating material composition) was electrostatically applied by using a rotary electrostatic coater to give a cured film thickness of 35 μm, and cured by heating at 140° C. for 30 minutes, and thus an intermediate coating film, which was an object to be coated, was produced.

### 2. Preparation of Coating Material

### Production of Acrylic Resin

### Production Example 1

To a reaction vessel equipped with a thermometer, a thermostat, a stirrer, a reflux condenser, a nitrogen-introducing tube, and a dropping device, 50 parts of xylene and 20 parts of butyl acetate were charged, and the temperature was increased to 115° C. Thereafter, a mixture of 5 parts of styrene, 50 parts of methyl methacrylate, 15.5 parts of n-butyl acrylate, 15 parts of 2-hydroxyethyl acrylate, 20 parts of “PLACCEL FM3X” (trade name, available from Daicel Corporation; xylene diluted product of 3 mol adduct of ε-caprolactone of 2-hydroxyethyl methacrylate; solid content: 80%), 1.5 parts of dimethylaminoethyl methacrylate, 1 part of acrylic acid, 15 parts of xylene, and 1.0 part of 2,2′-azobisisobutyronitrile was added dropwise over 3 hours. After the completion of the dropwise addition, the mixture was aged for 1 hour. A mixture of 5 parts of xylene and 1 part of 2,2′-azobis(2,4-dimethylvaleronitrile) was then further added dropwise over 1 hour, and after completion of the dropwise addition, the mixture was aged for 1 hour. Then, 10 parts of xylene was added, and a hydroxyl group-containing acrylic resin (R-1) solution with a solid content of 50% was produced. The resulting hydroxyl group-containing acrylic resin (R-1) had an acid value of 7.8 mg KOH/g, a hydroxyl value of 69.5 mg KOH/g, and a weight average molecular weight of 40000.

### Production of Photoluminescent Coating Material Composition (Y)

### Production Example 2

In a stirring and mixing container, 100 parts (solid content: 20 parts) of “LeafPowder 49CJ-1120” (trade name, available from Oike & Co., Ltd.; indium particle; solid content: 20%; dispersed in propylene glycol monomethyl ether), 0.28 parts (solid content: 0.08 parts) of “LE-605” (trade name, available from Kyoeisha Chemical Co., Ltd.; fluorine-based surface conditioner; solid content: 30%), and 1610 parts of propylene glycol monomethyl ether were added, stirred and mixed. A photoluminescent coating material composition (Y-1) having a solid content of 1.2 mass % was thus produced.

### Production Examples 3 to 9

The photoluminescent coating material compositions (Y-2) to (Y-8) were produced all in the same manner as in Example 1 except for employing formulations and solid contents described in Table 1.

TABLE 1
Table 1: Numerical value in parentheses indicates solid content

| | | | Production Examples | | | | | | | |
|---|---|---|---|---|---|---|---|---|---|---|
| Production Example No. | | | 2 | 3 | 4 | 5 | 6 | 7 | 8 | 9 |
| Name of photoluminescent coating | | | Y-1 | Y-2 | Y-3 | Y-4 | Y-5 | Y-6 | Y-7 | Y-8 |
| material composition | | | | | | | | | | |
| Formu- | Indium particle | ″LeafPowder | 100 | 100 | 100 | 100 | 100 | 100 | | 100 |
| lation | (y1) | 49CJ-1120″ | (20) | (20) | (20) | (20 | (20) | (20) | | (20) |
| | Photo- | 'METALURE | | | | | | | 100 | |
| | luminescent | L-71011AE″ | | | | | | | (10) | |
| | pigment other | (*1) | | | | | | | | |
| | than indium | | | | | | | | | |
| | particle (y1) | | | | | | | | | |
| | Surface | ″LE-605″ | 0.28 | 0.28 | 0.28 | 0.28 | 0.28 | 0.28 | 0.16 | |
| | conditioner (y2) | | (0.08) | (0.08) | (0.08) | (0.08) | (0.08) | (0.08) | (0.05) | |
| | Organic solvent | Propylene | 1610 | 772 | 626 | 343 | | 88 | 403 | 343 |
| | (y3) | glycol | | | | | | | | |
| | | monomethyl | | | | | | | | |
| | | ether | | | | | | | | |
| | | Isopropanol | | | | | 343 | | | |
| | Resin | Hydroxyl | | | 0.41 | | | | | |
| | | group- | | | (0.21) | | | | | |
| | | containing | | | | | | | | |
| | | acrylic resin | | | | | | | | |
| | | (R-1) | | | | | | | | |
| | Color pigment | ″R5000″ (*2) | | | 0.04 | | | | | |

| | | | | | | | | |
|---|---|---|---|---|---|---|---|---|
| Solid content (mass %) | 1.2 | 2.3 | 2.8 | 4.5 | 4.5 | 10.7 | 2.0 | 4.5 |

(*1) ″METALURE L-71011AE″: trade name, available from ECKART; vapor deposition aluminum flake pigment; solid content: 10%; dispersed in ethyl acetate.
(*2) ″R5000″ (*2): trade name, ″RAVEN 5000 ULTRA III BEADS″, available from Columbian Carbon Company; carbon black pigment.

### Preparation of Clear Coating Material Composition (Z)

### Clear Coating Material Composition (Z-1)

“KINO-6510” (trade name, Kansai Paint Co., Ltd.; hydroxyl group/isocyanate group-curable acrylic resin-urethane resin-based two-component organic solvent-type coating material containing a hydroxyl group-containing resin and a polyisocyanate compound) was used as a clear coating material (Z-1).

### Clear Coating Material Composition (Z-2)

“MAGICRON KINO-1210” (trade name, Kansai Paint Co., Ltd.; acrylic resin-based acid/epoxy curable solvent-type coating material) was used as a clear coating material (Z-2).

### 3. Preparation of Test Sheet

### Preparation of Test Sheet

### Example 1

On a substrate prepared in “1. Preparation of Substrate” described above, the photoluminescent coating material composition (Y-1) produced in “2. Preparation of Coating Material” described above was applied by using a minibell rotary electrostatic coater at a booth temperature of 23° C. and humidity of 63% in a manner that the film thickness as a cured coating film became 0.05 μm, allowed to stand for 15 minutes at room temperature, then heated in a hot air circulation type drying furnace at 140° C. for 30 minutes, and dried and cured. A photoluminescent coating film was thus produced.

Thereafter, on the photoluminescent coating film, the clear coating material composition (Z-1) adjusted in “2. Preparation of Coating Material” described above was applied by using a minibell rotary electrostatic coater at a booth temperature of 23° C. and humidity of 68% in a manner that the film thickness as a cured coating film became 35 μm, allowed to stand for 7 minutes at room temperature, then heated in a hot air circulation type drying furnace at 140° C. for 30 minutes, and dried and cured. A test sheet of Example 1 was thus produced.

Here, the dry coating film thickness of the photoluminescent coating film was calculated from the following equation. The same applies to the following examples.

$$x = sc / sg / S * 10000$$

x: Film thickness [μm]
sc: Solid content [g] coated by application
sg: Specific gravity of coating film [g/cm³]
S: Evaluated surface area [cm²] of the solid content coated by application

### Examples 2 and 4 to 7 and Comparative Examples 1 to 3

Test sheets were produced all in the same manner as in Example 1 except for paints and film thicknesses described in Table 2.

### Example 3

On a substrate prepared in “1. Preparation of Substrate” described above, the photoluminescent coating material composition (Y-2) produced in “2. Preparation of Coating material” described above was applied by using a minibell rotary electrostatic coater at a booth temperature of 23° C. and humidity of 63% in a manner that the film thickness as a cured coating film became 0.1 μm, allowed to stand for 15 minutes at room temperature, and then pre-heated in a hot air circulation type drying furnace at 80° C. for 3 minutes. An uncured photoluminescent coating film was thus produced.

Thereafter, on the uncured photoluminescent coating film, the clear coating material composition (Z-1) adjusted in “2. Preparation of Coating Material” described above was applied by using a minibell rotary electrostatic coater at a booth temperature of 23° C. and humidity of 68% in a manner that the film thickness as a cured coating film became 35 μm, allowed to stand for 7 minutes at room temperature, and then heated in a hot air circulation type drying furnace at 140° C. for 30 minutes to simultaneously dry and cure the photoluminescent coating film and the clear coating film. A test sheet of Example 3 was thus produced.

### Coating Film Evaluation

The coating film was evaluated by the following methods for each test sheet produced as described above, and the results are shown in Table 2.

Adhesiveness: Grid-like cut was formed on the multilayer coating film of the test sheet by a utility knife in a manner that the cut reached the base material, and thus a grid of 100 pieces of 2 mm×2 mm squares was made. Then, a cellophane adhesive tape was adhered to the surface. The adhesive tape was quickly peeled off, then a remaining state of the cross cut coating film was examined, and the adhesiveness was evaluated according to the criteria below. Pass is acceptable.

Pass: 100 pieces of squares of the cross cut coating film remained.

Fail: The number of remained squares of the cross cut coating film was 99 or less.

Specular gloss (60° gloss): A 60° gloss value was measured by using a gloss meter (micro-TRI-gloss, available from BYK-Gardner). A larger value indicates superior metallic luster. A value of 280 or greater is acceptable.

TABLE 2
Table 2

| | Examples | | | | | | | Comparative Examples | | |
|---|---|---|---|---|---|---|---|---|---|---|
| | 1 | 2 | 3 | 4 | 5 | 6 | 7 | 1 | 2 | 3 |
| Name of | Y-1 | Y-2 | Y-2 | Y-3 | Y-4 | Y-5 | Y-6 | Y-2 | Y-7 | Y-8 |
| photoluminescent | | | | | | | | | | |
| coating material | | | | | | | | | | |
| composition (Y) | | | | | | | | | | |
| Film thickness of | 0.05 | 0.10 | 0.10 | 0.20 | 0.20 | 0.20 | 0.50 | 0.10 | 0.20 | 0.20 |
| photoluminescent | | | | | | | | | | |
| coating film (μm) | | | | | | | | | | |
| Heating of | 140° C./ | 140° C./ | 80° C./ | 140° C./ | 140° C./ | 140° C./ | 140° C./ | 140° C./ | 140° C./ | 140° C./ |
| photoluminescent | 30 min | 30 min | 3 min | 30 min | 30 min | 30 min | 30 min | 30 min | 30 min | 30 min |
| coating film | | | | | | | | | | |
| Name of clear | Z-1 | Z-1 | Z-1 | Z-1 | Z-1 | Z-1 | Z-1 | Z-2 | Z-1 | Z-1 |
| coating material | | | | | | | | | | |
| composition (Z) | | | | | | | | | | |
| Adhesiveness | Pass | Pass | Pass | Pass | Pass | Pass | Pass | Fail | Fail | Pass |
| Specular gloss | 341 | 320 | 286 | 281 | 322 | 313 | 294 | 320 | 180 | 250 |
| (60° gloss) | | | | | | | | | | |

1. A multilayer coating film-forming method comprising:
(1) applying a photoluminescent coating material composition (Y) onto an object to be coated to form a photoluminescent coating film;
(2) applying a clear coating material composition (Z) containing a hydroxyl group-containing resin (z1) and a polyisocyanate compound (z2) onto the photoluminescent coating film produced in (1) to form a clear coating film; and
(3) heating, separately or simultaneously, the photoluminescent coating film formed in (1) and the clear coating film formed in (2) to cure the photoluminescent coating film and the clear coating film,
the photoluminescent coating material composition (Y) containing an indium particle (y1), a surface conditioner (y2), and an organic solvent (y3), and
a solid content of the photoluminescent coating material composition (Y) being from 0.1 to 15 mass %.

2. The multilayer coating film-forming method according to claim 1, wherein the photoluminescent coating material composition (Y) contains the indium particle (y1) in an amount of 70 parts by mass or greater with respect to 100 parts by mass of the total amount of the solid content of the photoluminescent coating material composition (Y).

3. The multilayer coating film-forming method according to claim 1, wherein the surface conditioner (y2) contains a fluorine-based surface conditioner.

4. The multilayer coating film-forming method according to claim 1, wherein the organic solvent (y3) contains at least one type of solvent selected from the group consisting of an alcohol-based solvent and a glycol ether-based solvent.

5. The multilayer coating film-forming method according to claim 2, wherein the surface conditioner (y2) contains a fluorine-based surface conditioner.

6. The multilayer coating film-forming method according to claim 2, wherein the organic solvent (y3) contains at least one type of solvent selected from the group consisting of an alcohol-based solvent and a glycol ether-based solvent.

7. The multilayer coating film-forming method according to claim 3, wherein the organic solvent (y3) contains at least one type of solvent selected from the group consisting of an alcohol-based solvent and a glycol ether-based solvent.

8. The multilayer coating film-forming method according to claim 5, wherein the organic solvent (y3) contains at least one type of solvent selected from the group consisting of an alcohol-based solvent and a glycol ether-based solvent.
